(19) United States
(12) Patent Application Publication
(10) Pub. No.: US 2021/0368890 A1
(43) Pub. Date: Dec. 2, 2021

(54) Antiviral Face Mask

(71) Applicant: Argentum Medical, LLC, Geneva, IL (US)

(72) Inventor: Raul BRIZUELA, St. Charles, IL (US)

(21) Appl. No.: 16/890,674

(22) Filed: Jun. 2, 2020

(51) Int. Cl. A41D 13/11; A41D 31/30; B32B 5/26; B32B 5/02

(52) U.S. Cl. CPC A41D 13/1192; A41D 31/305; B32B 2571/00; B32B 5/024; B32B 2311/08; B32B 5/26

(57) ABSTRACT

Disclosed herein are washable, reusable, antimicrobial and antiviral face masks and methods of their use for the reduction of transmission of infectious pathogens. Exemplary face masks are made of silver-coated material wherein activation of the silver from moisture in a user's breath kills pathogens. The disclosed face masks are useful in reducing, inhibiting or killing pathogens, such as SARS-CoV-2, that contact the face mask within 2 hours of continuous contact.

### TECHNICAL FIELD OF THE INVENTION

This invention is generally related to antimicrobial and antiviral face mask and methods of their use for reducing the spread of infection or illness from infectious pathogens.

### BACKGROUND OF THE INVENTION

Human health is under constant threat due to emerging and reemerging viral and bacterial infections. When infection from a new or reemerged disease spreads across a large geographical area, for example multiple countries or even worldwide, it is deemed a pandemic. Throughout human history there have been several, devastating pandemics of diseases such as smallpox, tuberculosis and influenza. The most fatal pandemic in recorded history was the Plague which killed an estimated 75-200 million people in the 14th century. Currently, the world is experiencing the COVID-19 pandemic.

Coronavirus disease 2019 (COVID-19) is an infectious disease caused by severe acute respiratory syndrome coronavirus 2 (SARS-CoV-2). Common symptoms of the disease include fever, cough, fatigue, shortness of breath, and loss of smell and taste. While the majority of cases result in mild symptoms, some progress to acute respiratory distress syndrome (ARDS) likely precipitated by cytokine storm, multi-organ failure, septic shock, and blood clots. COVID-19, like most diseases caused by newly emerged viruses, has no treatment or vaccine to date. Patients with severe disease are treated symptomatically, and often end up on a respirator for some time. In order to slow transmission of disease during the pandemic, health organizations recommend regular hand washing, covering mouth and nose when coughing and sneezing, wearing a face mask, keeping a safe distance from others, and avoiding close contact with anyone showing symptoms of respiratory illness such as coughing and sneezing.

Rapid, widespread community transmission in certain highly populated areas led to overcrowding in hospitals, and the use of more personal protective equipment (PPE) than normal in hospitals. This combined with an increase of fear-induced purchasing of hospital grade protective gear by the public has led to a shortage of PPE across the United States. There is strong evidence to suggest that wearing non-surgical grade face masks (or even cloth coverings over the face and nose) can reduce the transmission of COVID-19 if used in combination with “social distancing”, or keeping a safe distance of 6 feet from other with whom a person does not live with or interact with on a daily basis. However, most non-surgical face masks currently on the market only offer a physical barrier to the virus. There is a need for easily, rapidly manufactured face masks that confer both a physical barrier and biocidal properties to protect the general public from transmission of COVID-19 and other viruses while freeing up the surgical grade PPE such as N95 and filtered facepiece respirators for hospital workers and people at high risk of infection.

Therefore, it is an object of the invention to provide antimicrobial and antiviral face masks and methods of their use to prevent transmission of viruses and other pathogenic agents.

### SUMMARY OF THE INVENTION

Disclosed herein are antimicrobial and antiviral face masks useful in helping prevent transmission of infectious pathogens. An exemplary face mask includes a mask body having at least one layer of a silver-coated material, wherein the mask body is shaped such that it covers at least the mouth and nose of a subject, and a means to affix the face mask to the subject's face, wherein the means to affix the face mask to the subject's face is connected to the body of the mask. Without being bound by any one theory, it is believed that when the silver-coated fabric or material is moistened (e.g., with breathing), the silver ions are activated, which kill bacteria and viruses.

In one embodiment, the silver-coated material is a fabric made of woven silver plated porous nylon. In one embodiment the silver plated porous nylon can be plated with 99% silver and 1% silver oxide.

The disclosed face masks can be affixed to the subject's face by means of ear loops, tie straps, or headbands.

In one embodiment, the face mask body can include multiple layers. The face mask can include multiple layers of silver-coated material. The face mask can also include a filter layer between the layers of silver-coated material, or as an individual layer itself. The mask can also include a fabric or polymeric layer on the surface of the face mask body that interfaces with the subject's face.

In some embodiments, the face mask is prepared from a singular piece of silver-coated material with ear loops cut from the body. In other embodiments, the body is prepared from more than one piece of fabric fastened together with nylon thread.

Also disclosed are antiviral and antimicrobial face masks having a face mask body including at least one layer of a silver-coated fabric, at least one filter layer, and at least one non-silver-coated fabric layer; and ear loops attached to the body.

Also provided are methods of reducing pathogen transmission to a subject by affixing to the face of the subject one of the disclosed face masks, wherein activation of the silver by moisture from the subject's breath inactivates, kills, or reduces pathogen particles that contact the face mask before the particles are able to penetrate the mask and contact the subject's mouth or nose. In such embodiments, the pathogens are inactivated, killed, or reduced within 2 hours of contact. In other embodiment, the pathogens are inactivated, killed, or reduced within 1 hour of contact. The pathogen can be a virus such as SARS-CoV-2 virus. In one an embodiment, the SARS-CoV-2 virus is inactivated by a 5-log reduction within two hours of contact.

### BRIEF DESCRIPTION OF THE DRAWINGS

FIG. 1 is a photo of an exemplary design of the disclosed face masks.

FIG. 2 is a schematic illustration of an exemplary cut pattern for the disclosed face masks.

FIG. 3 is a schematic illustration showing an exemplary cut and folded layout of the disclosed face masks.

FIG. 4 is a schematic illustration showing an exemplary sewn layout of the disclosed face masks.

FIG. 5 is a front view of an exemplary single-layered face mask.

FIG. 6 is a front view of an exemplary multi-layered face mask.

FIG. 7 is a front view of an exemplary multi-layered face mask with a nose piece.

FIG. 8 is a front view of an exemplary multi-layered face mask with a nose piece and a HEPA filter pocket.

FIG. 9 is a front view of an exemplary single-layered face mask with a nose piece and ties.

### DETAILED DESCRIPTION OF THE INVENTION

### I. Definitions

It should be appreciated that this disclosure is not limited to the compositions and methods described herein as well as the experimental conditions described, as such may vary. It is also to be understood that the terminology used herein is for the purpose of describing certain embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any compositions, methods and materials similar or equivalent to those described herein can be used in the practice or testing of the present invention. All publications mentioned are incorporated herein by reference in their entirety.

The use of the terms “a,” “an,” “the,” and similar referents in the context of describing the presently claimed invention (especially in the context of the claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, the terms “outside” and “outer surface”, refer to that portion, or surface, respectively, of the mask (or of any element thereof) which is disposed away from the face of the wearer when the mask is in place; the terms “inside” and “inner surface” refer to that portion, or surface, respectively, of the mask (or of any element thereof) which contacts or is disposed toward the face of the wearer when the mask is in place. The term “upper,” as used herein, refers to that part of the mask (or of any element thereof) which is nearer the nose and eyes of the wearer when the mask is in place; the term “lower’ refers to that part of the mask (or of any element thereof) which is nearer the chin of the wearer when the mask is in place.

As used herein, “virucide” refers to any physical or chemical agent that deactivates or destroys viruses. “Virucidal” refers to the ability to deactivate or destroy viruses.

As used herein, “bactericide” refers to a substance or organism that kills bacteria. “Bactericidal” refers to the ability to kill bacteria.

As used herein, “antibacterial” refers to anything that destroys bacteria or suppresses their growth or their ability to reproduce. Heat, chemicals, and antibiotic drugs all have antibacterial properties.

As used herein, “antimicrobial” refers to anything that destroys or inhibits the growth of microorganisms, include bacteria, viruses, and fungi.

As used herein, “pathogen” refers to a bacterium, virus, or other microorganism that can cause disease.

“Log reduction” refers to the measurement of how thoroughly a decontamination process reduces the concentration of a contaminant. It is defined as the common logarithm of the ratio of levels of contamination before and after the process. An increment of 1 corresponds to a reduction in concentration by a factor of 10. So for example, a 0-log reduction is no reduction at all, while a 1-log reduction corresponds to a reduction of 90 percent from the original concentration, and a 2-log reduction corresponds to a reduction of 99 percent from the original concentration, etc.

As used herein “personal protective equipment” or “PPE” refers to protective clothing, helmets, goggles, or other garments or equipment designed to protect the wearer's body from injury or infection. In the healthcare field, PPE can include respirators, face masks, face shields, gloves, gowns, hair coverings, shoe coverings, and goggles.

### II. Antimicrobial and Antiviral Face Mask

Disclosed herein are antimicrobial and antiviral face masks and methods of their use for helping prevent the spread of infection or illness from pathogens. Most materials used in the manufacture of personal protective equipment (PPE) are passive to bacterial and viral stability, which require careful donning and disposal of these items. Active materials that reduce bacterial and viral stability are an important adjunct defense mechanism against infection. The disclosed masks are made from a silver-coated material. The antimicrobial and antiviral property of the elemental silver material offers a biocidal defense to help reduce transmission of microbes and pathogens, which is an important benefit over source control face masks that provide only a physical barrier.

Without being bound by any one theory, it is believed that when the silver-coated fabric or material is moistened (e.g., with breathing), the silver ions are activated, which kill bacteria and viruses. Silver ions can incorporate into the bacterial or viral cell membranes and bind to membrane proteins responsible for transport of substances in and out of the cells, thus blocking transport of key nutrients into the cell. Silver ions are also transported into the cells and will block cell division by binding to the DNA. Silver ions can also block the bacterial respiratory system and thereby destroy the energy production of the cell. In the end, the bacterial cell membrane will burst, and the bacteria will be destroyed. The antimicrobial and antiviral properties of the activated silver ions helps to kill bacteria and viruses on the surfaces of the mask.

The disclosed face masks are an improvement over currently available non-surgical face masks because the disclosed face masks are reusable, washable, and provide not only a physical barrier to pathogens but also have antimicrobial and antiviral properties. The widespread use of the disclosed face masks by the public could free up surgical grade PPE for frontline workers and individuals at a high risk for becoming infected due to pre-existing health conditions.

A. Silver-Coated Fabric

As described above, the antimicrobial and antiviral face masks are made of at least one layer of silver-coated fabric, cloth, or a similar material. Silver-coated fabrics are commercially available, for example Silverlon®. See also U.S. Pat. Nos. 7,005,556; 7,230,153; 8,293,964; 8,283,513; 8,449,514; and 8,455,710 which are incorporated by reference in their entirety. In another embodiment, the face masks are made of a fabric, cloth, or similar material that is coated with another metal with medically useful bactericidal or bacteriostatic properties such as but not limited to copper, gold, palladium nickel, cobalt or an alloy of nickel and boron, cobalt and boron, palladium and boron, nickel and phosphorus, cobalt and phosphorus, palladium and phosphorus, or combinations thereof.

The metallized fabric can be made by weaving, knitting, crocheting, felting, blowing, or some other convenient process. In one embodiment, the fabric is made of silver-coated nylon fibers woven together. However, other materials may also be suitable, including nonwoven sheet material that incorporate or are coated with suitable amounts of silver. Silver may be added to the fibers of the face mask fabric by electrolytic vapor coating, aerosolized deposition, sputter coating or other standard techniques known in the art. Individual fibers can be coated and then worked (woven, knitted, crocheted, felted, blown, etc.) into fabric. Alternatively, suitable amounts of silver may be added to the finished fabric. While the thickness of such a silver coating may vary broadly, the amount of silver should be such that the fabric has a specific resistance no greater than approximately 10 Ω/cm². In another embodiment, the amount of silver should be such that the fabric has a specific resistance of approximately 10 Ω/cm² to 0.001 Ω/cm². In another embodiment, the amount of silver should be such that the fabric has a specific resistance of 1 Ω/cm² to 0.01 Ω/cm². Typically, a medically-useful material for a face mask contains at least approximately 5 wt. % silver, preferably approximately 20 wt. % silver. However, the metal content and specific resistance of the fabric, as well as the thickness and uniformity, may vary broadly depending on the selected metal. Thus, fabrics with lesser amounts of metal may also be useful in the practice of the invention.

In one embodiment, the silver-coated fabric for the face masks is made from silver plated porous nylon, plated with 99% silver and 1% silver oxide. In other embodiments, the porous nylon is coated with at least 90%, 91% 92%, 93%, 94%, 95%, 96%, 97%, 98%, or 99% silver and at least 1%, 2%, 3%, 4%, 5%, 6%, 7%, 8%, 9%, or 10% silver oxide.

Ideally, the metallic silver used for the face masks is of high purity, preferably from about 99.0% to about 99.6% pure, although lower purity levels can also function. It is believed that high purity reduces the likelihood that contaminants or undesirable ions may contact or penetrate through the mask. The silver-coated fabric or material can be in the form of fibers. The range of denier of the fibers can be from about 0.0001 denier to about 10,000 denier, preferably from about 1.0 denier to about 1000 denier, and more preferably from about 5 denier to about 300 denier. The various cross-sectional shapes that may be imparted to individual fibers are known to those skilled in the art, and include, but are not limited to, round, oval, kidney bean, dogbone, flat, tri-lobal, and multi-lobal. In general, while not wishing to be bound to any particular theory, it is believed that the greater the surface area of the fiber, the greater the surface area of metallic plated fibers, forming an active surface area, which can result in greater release of metallic ions and a more effective face mask. Individual fibers may be fabricated into several different types of yarns including, but not limited to, spun yarns, filament yarns, compound yarns, fancy yarns, and combinations thereof. Fibers can be configured into tow and floc and can be provided in the form of staple or bulk continuous filament. It is believed that the greater the continuity of the yarns, the greater the potential for excellent conductivity when plated. Fibers and/or yarns can be assembled into fabrics, including but not limited to, woven fabrics, twisted and knotted fabrics, knit fabrics, non-woven fabrics, and compound/complex fabrics. It is proposed that the total surface area of the fibers that compose the filaments, fibers, yarns or fabric is a variable in determining antimicrobial and antiviral properties.

The thickness of the uniform coating can vary from about 0.1 micrometers to about 2.0 microns, from about 0.1 microns to about 1 micron, from about 0.1 microns to about 1.5 microns, preferably from about 0.2 microns to about 1.5 microns. The thickness of metal coating is directly correlated with the percentage of weight of silver plated to the weight of the fabric without silver plating. The amount of coating can vary from about 5% to about 40% by weight, from about 5% to about 30% by weight, from about 5% to about 20% by weight, from about 5% to about 10% by weight, from about 10% to about 30% by weight, from about 10% to about 25% by weight, from about 10% to about 20% by weight, from about 15% to about 30% by weight, more preferably between about 15% to about 22% by weight.

B. Face Mask

In one embodiment, the body of the face mask is made entirely of the silver-coated fabric. The face mask can be cut from a singular piece of silver-coated fabric without the need for thread or fasteners. In such an embodiment, the face mask is a single-layer face mask with cut outs in the fabric to provide ear loops to affix the face mask to the face. Another embodiment provides a pleated face mask.

In another embodiment, the face mask is made from multiple pieces of silver-coated fabric or material with thread or fastening devices used to hold parts of the mask together. Exemplary threads that can be used to connect pieces of the face mask together include but are not limited to cotton, wool, silk, linen, rayon, polyester, or nylon. The thread can be all-purpose thread, clear thread, elastic thread, heavy duty thread, industrial thread, serger thread, thread with metalized coating, or textured nylon thread. In one embodiment, the thread is 100% polyester serger thread.

The multiple pieces of the face mask can also be affixed to each other using an adhesive material. Exemplary adhesives include but are not limited to glues, tapes, spray adhesives, melt adhesives, chemical welding, and heat welding.

In some embodiments, the face mask includes more than one layer of silver-coated fabric or material. The face mask can have 1, 2, 3, or more than 3 layers of silver-coated fabric or material. In embodiments in which the mask contains several layers of silver-coated fabric or material, a pocket for a filter can exist between the layers. In such an embodiment, the filter can be a HEPA filter. HEPA stands for High Efficiency Particulate Air. HEPA filters are designed to arrest very fine particles effectively, but they do not filter out gasses and odor molecules. In another embodiment, the filter is a non-removable layer between two silver-coated fabric layers.

In another embodiment, the face mask can include additional layers of non-silver-coated materials. The materials can be used as a liner on the face of the mask that contacts the user's face. The materials can improve comfort or increase filtration of microbes. Exemplary materials that can be used to line the face mask include but are not limited to cotton fabric, polyester, filtration medium formed from fibers such as, fiberglass, polyester, polypropylene, vinyon fibers and similar materials.

In one embodiment, the face mask is sewn to provide a contoured fit around the nose. In another embodiment, the face mask includes a malleable structure that conforms the mask to the nose. In such an embodiment, the malleable structure can include but is not limited to wire, aluminum or another malleable metal strip, or a moldable plastic. In some embodiments, the face mask includes fabric or padding under the nose piece for comfort.

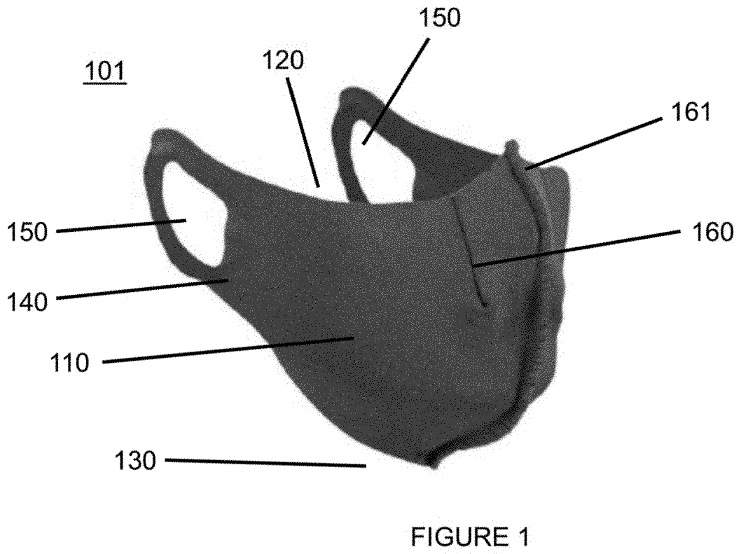

The face masks include a structure to affix the mask to the face. In one embodiment, the face mask has tie strings that are tied behind the head and or neck to affix the mask to the face. The ties strings can be made out of the silver-coated fabric or a different type of fabric or material. In another embodiment, the face mask has cut outs in the material to provide ear loops (See FIG. 1). In yet another embodiment, the face mask has ear loops affixed to the mask. The ear loops can be made of fabric or they can be made from elastic or another stretchy material. In some embodiments, the face mask has loops to go over the head and affix the mask to the face.

In one embodiment, the disclosed face masks are washable and reusable. The masks can be washed with cold or warm water with a detergent or soap. In some embodiments, the masks can be washed in a washing machine. The masks can be washed up to 200 times and still maintain their antimicrobial and antiviral activity. The masks can be air dried or they can be dried in a machine drier on a low temperature setting. In another embodiment, the mask can be decontaminated with antiviral or antibacterial products including but not limited to alcohol such as ethyl alcohol or isopropyl alcohol, antibacterial or antimicrobial soaps or detergents, disinfectants containing hydrogen peroxide, or any other antimicrobial or antibacterial cleaning product or agent.

Exemplary embodiments of the disclosed face masks as shown in FIGS. 1-9.

FIG. 1 is a picture of an exemplary face mask 101 having face mask body 110, an upper side 120 to be positioned a top the wearer's nose, a lower side 130 to be positioned on or beneath the wearer's chin, sides 140 to be positioned on either side of the wearer's face near the ears, ear loops 150 to secure mask 101 around the wearer's ear, nylon thread seams 160 to secure face mask 101 tightly around the wearer's nose, and nylon thread seams 161 to hold the pieces of body 110 together in embodiments in which the body is cut from several pieces of fabric.

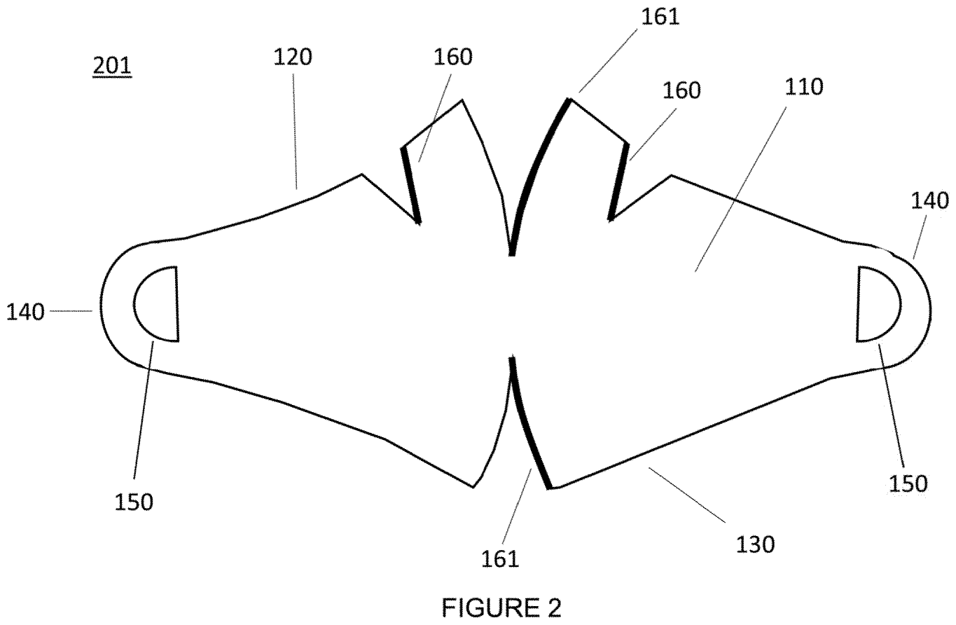

FIG. 2 is a schematic illustration of an exemplary cut face mask pattern 201 used to prepare mask 101 having face mask body 110, an upper side 120 to be positioned a top the wearer's nose, a lower side 130 to be positioned on or beneath the wearer's chin, sides 140 to be positioned on either side of the wearer's face near the ears, ear loops 150 to secure mask 101 around the wearer's ear, and nylon thread seams 160 to secure face mask 101 tightly around the wearer's nose.

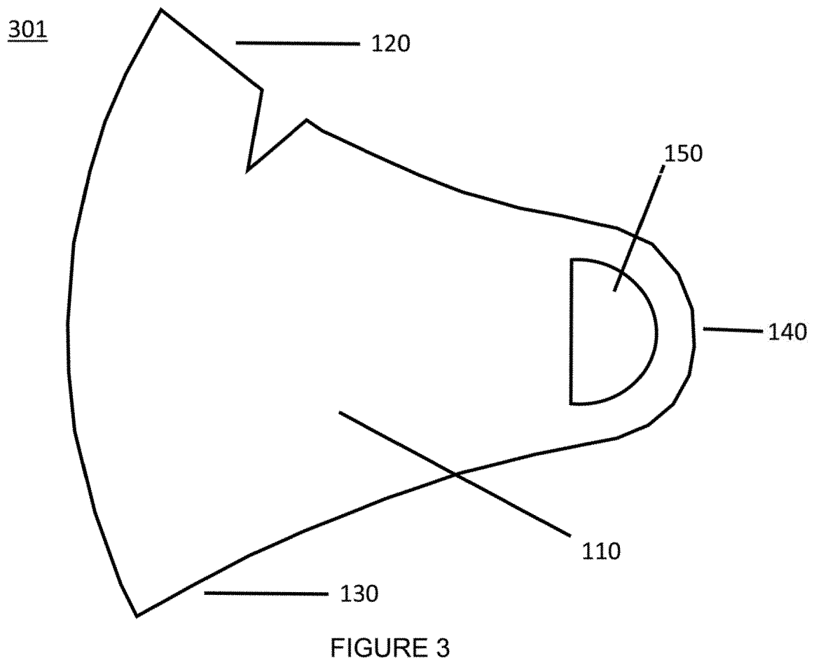

FIG. 3 is a schematic illustration of an exemplary cut and folded face mask pattern 301 used to prepare mask 101 having face mask body 110, an upper side 120 to be positioned a top the wearer's nose, a lower side 130 to be positioned on or beneath the wearer's chin, sides 140 to be positioned on either side of the wearer's face near the ears, and ear loops 150 to secure mask 101 around the wearer's ear.

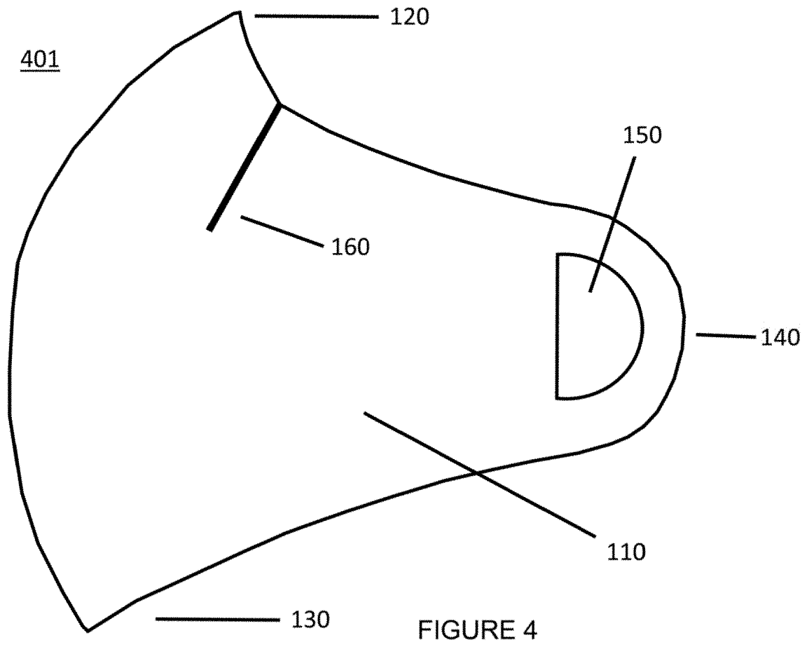

FIG. 4 is a schematic illustration of an exemplary cut, folded, and sewn face mask pattern 401 used to prepare mask 101 having face mask body 110, an upper side 120 to be positioned a top the wearer's nose, a lower side 130 to be positioned on or beneath the wearer's chin, sides 140 to be positioned on either side of the wearer's face near the ears, ear loops 150 to secure mask 101 around the wearer's ear, and nylon thread seams 160 to secure face mask 101 tightly around the wearer's nose.

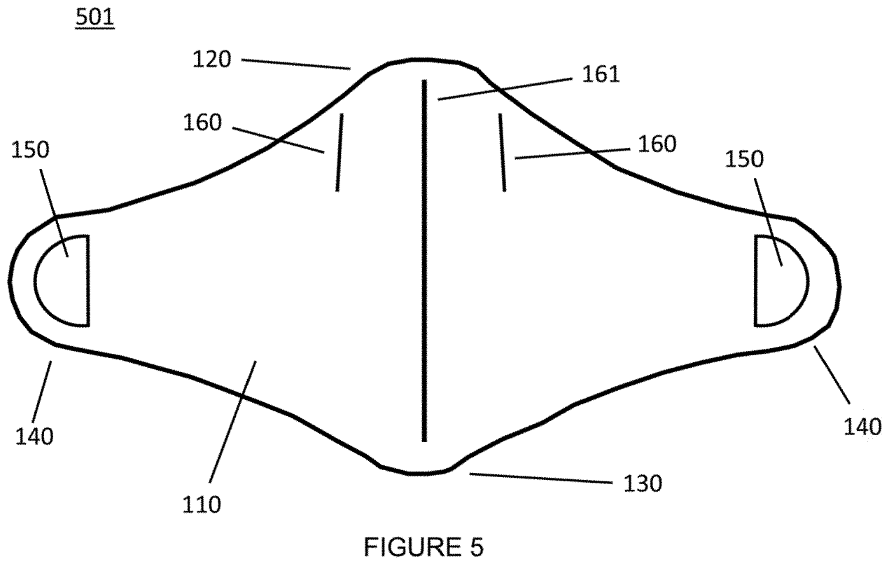

FIG. 5 is a front view 501 of exemplary face mask 101 having face mask body 110, an upper side 120 to be positioned a top the wearer's nose, a lower side 130 to be positioned on or beneath the wearer's chin, sides 140 to be positioned on either side of the wearer's face near the ears, ear loops 150 to secure mask 101 around the wearer's ear, nylon thread seams 160 to secure face mask 101 tightly around the wearer's nose, and nylon thread seams 161 to hold the pieces of body 110 together in embodiments in which the body is cut from several pieces of fabric.

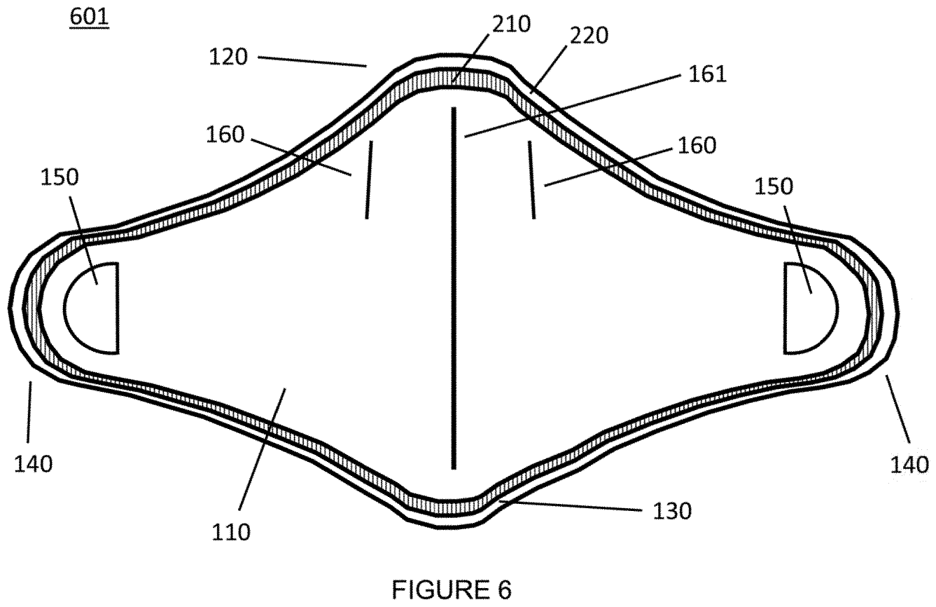

FIG. 6 is a schematic illustration of exemplary multi-layered face mask 601 having face mask body 110, an upper side 120 to be positioned a top the wearer's nose, a lower side 130 to be positioned on or beneath the wearer's chin, sides 140 to be positioned on either side of the wearer's face near the ears, ear loops 150 to secure mask 601 around the wearer's ear, nylon thread seams 160 to secure face mask 101 tightly around the wearer's nose, nylon thread seams 161 to secure pieces of body 110 together, HEPA filter layer 210, and a second layer of material 220. Layer 220 can be a second layer of silver plated fabric, or a non-silver coated material.

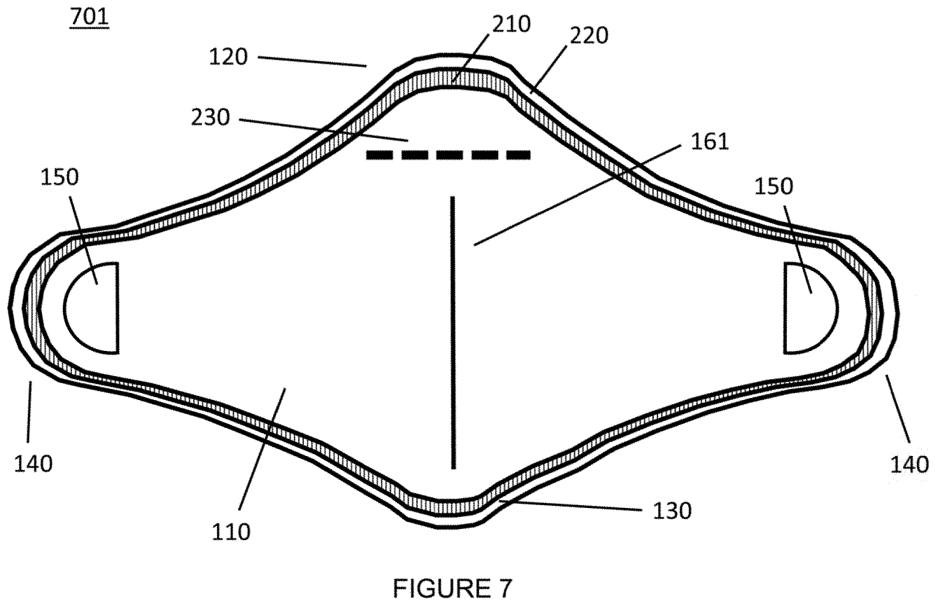

FIG. 7 is a schematic illustration of exemplary multi-layered face mask 701 having face mask body 110, an upper side 120 to be positioned a top the wearer's nose, a lower side 130 to be positioned on or beneath the wearer's chin, sides 140 to be positioned on either side of the wearer's face near the ears, ear loops 150 to secure mask 701 around the wearer's ear, nylon thread seams 161 to secure pieces of body 110 together, HEPA filter layer 210, and a second layer of material 220, and nose piece 230. Layer 220 can be a second layer of silver plated fabric, or a non-silver coated material.

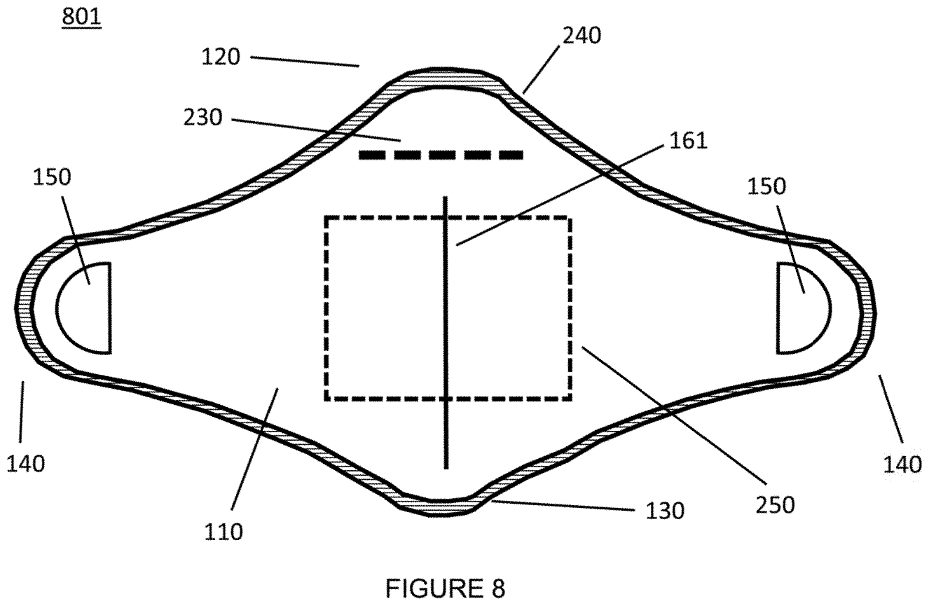

FIG. 8 is a schematic illustration of exemplary multi-layered face mask 801 having face mask body 110, an upper side 120 to be positioned a top the wearer's nose, a lower side 130 to be positioned on or beneath the wearer's chin, sides 140 to be positioned on either side of the wearer's face near the ears, ear loops 150 to secure mask 801 around the wearer's ear, nylon thread seams 161 to secure pieces of body 110 together, fabric liner layer 240, nose piece 230, and HEPA filter pocket 250 for a replaceable filter. In another embodiment, HEPA filter pocket 250 contains a permanent filter that is affixed permanently to the mask and is not replaceable.

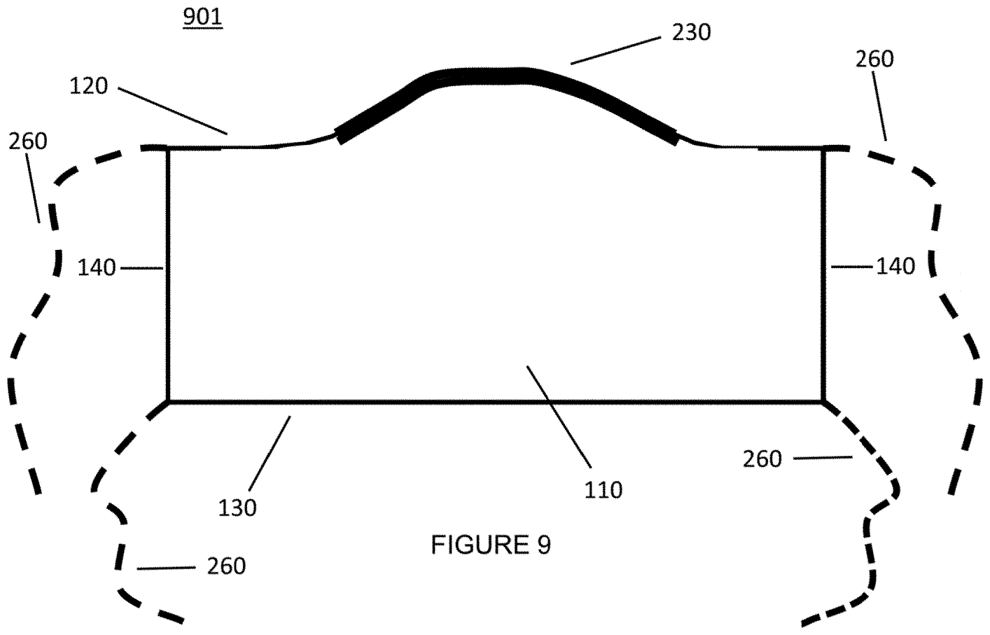

FIG. 9 is a schematic illustration of an exemplary face mask 901 having face mask body 110, an upper side 120 to be positioned a top the wearer's nose, a lower side 130 to be positioned on or beneath the wearer's chin, sides 140 to be positioned on either side of the wearer's face near the ears, ties 260 to secure mask 901 around the wearer's head, and nose piece 230. Face mask 901 can also incorporate any of the design elements of face masks 101, 601, 701, and 801 including but not limited to multiple layers, nylon thread seams to hold the mask secure on the nose, HEPA filter layers, fabric liner layers, nose pieces, or any combination thereof.

### III. Methods of Use

The disclosed face masks have antimicrobial and antiviral properties, and as such can be used to help prevent the spread of infection and illness due to a variety of microbes and pathogens. When the silver-coated fabric or material is moistened, for example with respiratory droplets from the wearer's breath, the silver ions are activated and can inactivate or kill viruses.

The disclosed face masks are useful in reducing or preventing viral replication and transmission, for example to reduce or prevent replication and transmission of enveloped viruses or nonenveloped viruses. The viruses can be DNA viruses or RNA viruses. In another embodiment, the disclosed face masks are useful in preventing bacterial infection.

In one embodiment, the disclosed face masks are used as a primary mask for the general public and healthcare providers in lower infection risk clinical settings. In such an embodiment, a user wears the face mask over the mouth and nose such that the user is breathing air from the outside environment only as it is filtered through the facemask. In order to use the face mask, the user must orient the mask such that the nylon thread seams 160, or nose piece 230 are oriented on either side of or sitting on the nose, respectively, and pull the ear loops (or straps) over the ears such that the mask body covers the mouth and nose. In another embodiment, the face mask is in the style of a surgical face mask.

In another embodiment, the mask may be worn as a secondary mask over N95 or Filtering Facepiece Respirators (FFRs) to help keep the surface of these masks decontaminated and help reduce the risk of hand or environmental contamination from handling disposable masks. In such an embodiment, the user must orient the mask such that such that the nylon thread seams 160, or nose piece 230 are oriented on either side of or sitting on the nose, respectively, and pull the ear loops (or straps) over the ears such that the mask body covers the N95 mask.

A. Viruses

Viruses cannot replicate outside of a host because they rely on enzymes within the host for replication. For the virus to reproduce and thereby establish infection, it must enter cells of the host organism and use those cells' materials. To enter the cells, proteins on the surface of the virus interact with proteins of the cell. Attachment, or adsorption, occurs between the viral particle and the host cell membrane. A hole forms in the cell membrane, then the virus particle or its genetic contents are released into the host cell, where replication of the viral genome may commence. Next, a virus must take control of the host cell's replication mechanisms. It is at this stage a distinction between susceptibility and permissibility of a host cell is made. Permissibility determines the outcome of the infection. After control is established and the environment is set for the virus to begin making copies of itself, replication occurs quickly by the millions. After a virus has made many copies of itself, it has usually exhausted the cell of its resources. The host cell is now no longer useful to the virus, therefore the cell often dies and the newly produced viruses must find a new host. The process by which virus progeny are released to find new hosts, is called shedding. This is the final stage in the viral life cycle.

Some viruses can “hide” within a cell, either to evade the host cell defenses or immune system, or simply because it is not in the best interest of the virus to continually replicate. This hiding is deemed latency. During this time, the virus does not produce any progeny, it remains inactive until external stimuli—such as light or stress—prompts it to activate. In one embodiment, the disclosed face masks inactivate or kill latent viruses that come into contact with the mask through respiratory droplets, airborne transmission, or touch contact from the user contacting the face mask with a contaminated surface.

a. Nonenveloped Virus

In one embodiment, the disclosed face masks are used to reduce or prevent replication and transmission of nonenveloped viruses. Exemplary nonenveloped viruses include but are not limited to adenoviruses, human papillomavirus, parvovirus B19, human astrovirus, Norwalk virus (norovirus), hepatitis E virus, rotavirus, orbivirus, coltivirus, poliovirus, Coxsackie viruses, echoviruses, hepatitis A virus, and Banna virus.

In one embodiment, the disclosed face masks are used to reduce or prevent replication and transmission of Picornaviruses. Picornaviruses are small (20-30 nm) nonenveloped viruses composed of an icosahedral nucleocapsid and a single-stranded RNA genome. Picornaviruses replicate in the cytoplasm of cells. They are not inactivated by lipid solvents, such as ether, because they do not have an envelope. The picornavirus family includes two groups of medical importance: the enteroviruses and the rhinoviruses. Among the major enteroviruses are poliovirus, Coxsackie viruses, echoviruses, and hepatitis A virus.

Poliovirus has tropism for epithelial cells of the alimentary tract and cells of the central nervous system. Infection is asymptomatic or causes a mild, undifferentiated febrile illness. Spinal and bulbar poliomyelitis occasionally occurs. Paralytic poliomyelitis is not always preceded by minor illness. Paralysis is usually irreversible, and there is residual paralysis for life. All three poliovirus serotypes (1 to 3) can give rise to paralytic poliomyelitis.

Most coxsackievirus infections are in apparent or mild. Rashes and vesicular lesions are most commonly caused by group A coxsackieviruses and pleurodynia and viral pericarditis/myocarditis by group B coxsackieviruses. The coxsackievirus A24 variant causes epidemic and pandemic outbreaks of acute hemorrhagic conjunctivitis. Occasionally, coxsackieviruses are associated with paralytic and encephalitic diseases. Coxsackieviruses are characterized by their pathogenicity for suckling mice. They are classified by antibody neutralization tests as coxsackievirus group A (A1 to A24) and coxsackievirus group B (B1 to B6).

Echoviruses have been associated with febrile and respiratory illnesses, aseptic meningitis, rash, occasional conjunctivitis, and paralytic diseases.

Enterovirus types 68 and 69 cause respiratory illnesses; type 70 causes acute hemorrhagic conjunctivitis and occasionally polio-like radiculomyelitis; type 71 can cause meningitis, encephalitis and outbreaks of hand-foot-mouth disease with or without encephalitis.

There is only one serotype of Hepatitis A virus. This virus causes gastroenteritis infections and hepatitis A, a disease of the liver. Many cases have few or no symptoms, especially in the young. The time between infection and symptoms, in those who develop them, is between two and six weeks. When symptoms occur, they typically last eight weeks and may include nausea, vomiting, diarrhea, jaundice, fever, and abdominal pain. Hepatitis A is transmitted via fecal-oral route.

Rhinoviruses cause mainly respiratory infections including the common cold. There are to date 115 serotypes. Immunity is type specific. Rhinovirus infections are among the most prevalent of acute respiratory illnesses in humans. More than 90 percent of susceptible individuals infected with rhinoviruses succumb to the infection. Although most rhinovirus infections manifest as mild common colds with rhinorrhea, nasal obstruction, fever, sore throat, coughs, and hoarseness lasting for a few days, serious lower respiratory tract illnesses in infants are common. The incubation period is a few days. Viral shedding begins several days after infection peaks shortly after the onset of symptoms, and may persist for a few weeks.

In another embodiment, the disclosed face masks are used to reduce or prevent replication and transmission of adenoviruses. Adenoviruses are medium-sized (90-100 nm), nonenveloped viruses with an icosahedral nucleocapsid containing a double stranded DNA genome. In humans, there are 57 accepted human adenovirus types (HAdV-1 to 57) in seven species (Human adenovirus A to G). Different types and serotypes of adenoviruses are associated with different conditions and diseases. For example, species HAdv-B and C cause respiratory disease, species HAdv-B and HAdv-D cause conjunctivitis, species HAdv-F types 40 and 41 and HAdv-G type 52 cause gastroenteritis. Adenoviruses are unusually stable to chemical or physical agents and adverse pH conditions, allowing for prolonged survival outside of the body and water. Adenoviruses are spread primarily via respiratory droplets, however they can also be spread by fecal routes. In one embodiment, the disclosed face masks can kill or reduce the number of adenoviruses that come into contact with the mask through respiratory droplets, airborne transmission, or touch contact from the user contacting the face mask with a contaminated surface.

In some embodiments, the disclosed compositions and methods are used to reduce or prevent replication and transmission of parvoviruses. In one embodiment, the parvovirus is parvovirus B19. The virus is primarily spread by infected respiratory droplets, but has been shown to be transmittable through blood-borne transmission. Symptoms begin about six days after exposure (between 4 and 28 days, with the average being 16 to 17 days) and last about a week. Infected subjects with normal immune systems are contagious before becoming symptomatic, but generally are not contagious after showing symptoms. Fifth disease or erythema infectiosum is one of several expressions of parvovirus B19.

In another embodiment, disclosed compositions and methods are used to reduce or prevent replication and transmission of norovirus. Noroviruses are a genetically diverse group of single-stranded positive-sense RNA, non-enveloped viruses belonging to the family Caliciviridae. Noroviruses are transmitted directly from person to person, and indirectly via contaminated water and food. They are extremely contagious, and fewer than twenty virus particles can cause an infection. In humans, the virus is replicated within the small intestine. One to two days after infection with norovirus, symptoms can appear. The principal symptom is acute gastroenteritis that develops between 12 and 48 hours after exposure, and lasts for 24-72 hours. The disease is usually self-limiting, and characterized by nausea, forceful vomiting, watery diarrhea, and abdominal pain, and in some cases, loss of taste. General lethargy, weakness, muscle aches, headache, cough, and low-grade fever may occur. Hand washing with soap and water is the only widely-accepted method for reducing the transmission of norovirus pathogens. In one embodiment, the disclosed face masks can kill or reduce the number of noroviruses that come into contact with the mask through respiratory droplets, airborne transmission, or touch contact from the user contacting the face mask with a contaminated surface.

b. Enveloped Virus

In another embodiment, the disclosed face masks are used to reduce or prevent replication and transmission of enveloped viruses. Exemplary enveloped viruses include but are not limited to herpes simplex type 1, herpes simplex type 2, varicella-zoster virus, Epstein-Barr virus, human cytomegalovirus, human herpesvirus type 8, smallpox, hepatitis B virus, Severe acute respiratory syndrome-related coronaviruses including Severe acute respiratory syndrome virus and Severe acute respiratory syndrome coronavirus 2, hepatitis C virus, yellow fever virus, dengue virus, West Nile virus, TBE virus, rubella virus, human immunodeficiency virus, influenza virus, Lassa virus, Crimean-Congo hemorrhagic fever virus, Hantaan virus, Ebola virus, and Marburg virus.

B. Bacteria

In one embodiment, the disclosed face masks prevent bacterial transmission to a subject exposed to an airborne, respiratory transmitted, or orally transmitted bacteria. In such an embodiment, the face mask inactivates or kills bacteria that adhere to the mask through respiratory droplets, airborne transmission, or touch contact from the user contacting the face mask with a contaminated surface.

Exemplary bacteria that can be inactivated, reduced or killed by contacting the mask include, but are not limited to, Actinomyces, Anabaena, Bacillus, Bacteroides, Bdellovibrio, Bordetella, Borrelia, Campylobacter, Caulobacter, Chlamydia, Chlorobium, Chromatium, Clostridium, Corynebacterium, Cytophaga, Deinococcus, Escherichia, Francisella, Halobacterium, Heliobacter, Haemophilus, Hemophilus influenza type B (HIB), Histoplasma, Hyphomicrobium, Legionella, Leishmania, Leptspirosis, Listeria, Meningococcus A, B and C, Methanobacterium, Micrococcus, Myobacterium, Mycoplasma, Myxococcus, Neisseria, Nitrobacter, Oscillatoria, Prochloron, Proteus, Pseudomonas, Phodospirillum, Rickettsia, Salmonella, Shigella, Spirillum, Spirochaeta, Staphylococcus, Streptococcus, Streptomyces, Sulfolobus, Thermoplasma, Thiobacillus, and Treponema, Vibrio, Yersinia, Cryptococcus neoformans, Histoplasma capsulatum, Candida albicans, Candida tropicalis, Nocardia asteroides, Rickettsia ricketsii, Rickettsia typhi, Mycoplasma pneumoniae, Chlamydial psittaci, Chlamydial trachomatis, Plasmodium falciparum, Plasmodium vivax, Trypanosoma brucei, Entamoeba histolytica, Toxoplasma gondii, Trichomonas vaginalis and Schistosoma mansoni.

The disclosed face masks provide an active biocidal and physical barrier, and as such are helpful in reducing the spread of the SARS-CoV-2 virus during the COVID-19 pandemic. In one embodiment, the disclosed face masks reduce SARS-CoV-2 virus by a 5-log reduction within two hours of contact with the face mask. In another embodiment, the face masks reduce the amount of SARS-CoV-2 virus present on the mask within 10 minutes, 20 minutes, 30 minutes, 40 minutes, 50 minutes, 60 minutes, 70 minutes, 80 minutes, 90 minutes, 100 minutes, 110 minutes, or 120 minutes.

### EXAMPLES

### Example 1. Virucidal Efficacy of Silverlon® Against SARS-CoV-2 Virus

Materials and Methods:

The objective of this project was to determine the virucidal efficacy of Silverlon® against SARS-CoV-2. The USA-WA1/2020 strain of the virus, acquired from BEI Resources (NR-52281) was used. This was propagated in Vero E6 cells (ATCC CRL-1586); these cells were also used for the TCID50 assay. Vero E6 cells were cultured in growth media consisting of Dulbeco's Modified Eagle Medium supplemented with 5% FBS, Glutamax, and PSN (penicillin, streptomycin, and neomycin).

Silverlon® and nylon were cut into 1″ by 1″ squares and placed into 6 well plates; three squares of each material were included for each of the 3 timepoints. The bandage squares were first activated by adding 500 μL of DI to the Silverlon®, Nylon and control wells for 15 minutes prior to addition of virus stock. Each well then received 500 μL of virus and was incubated for 2, 4, or 6 hours at room temperature on a plate shaking platform set to 100 rpm to ensure that the virus solution was evenly spread over the bandages. At each time point, 100 μL of virus solution was collected from each well and serially diluted to obtain the TCID50 in each well. The dilutions were plated in quintuplicate onto Vero cells that had been seeded on 96-well plates the day before the assay. The operator confirmed that these cells had reached ˜70% confluence on the day of the assay. The Vero cells were observed for cytopathic effects (CPE) associated with successful SARS-CoV-2 infection at 2 (preliminary) and 5 (final) days later. The results for Day 5 are shown in Table 1.

TABLE 1
Data from the Virus Neutralization Assay.

| Contact Time and | | | Log reduction to |
|---|---|---|---|
| Treatment | TCID50 | Log10 TCID50 | Virus Control |
| Silverlon ™ 2 h | 0* | 0* | 5.5 |
| Nylon 2 h | 112893 | 5.1 | 0.4 |
| Untreated Virus 2 h | 316228 | 5.5 | 0 |
| Silverlon ™ 4 h | 0 | 0 | 5.1 |
| Nylon 4 h | 138538 | 5.1 | 0 |
| Untreated Virus 4 h | 125893 | 5.1 | 0 |
| Silverlon ™ 6 h | 0 | 0 | 4.5 |
| Nylon 6 h | 35776 | 4.6 | −0.05 |
| Untreated Virus 6 h | 31623 | 4.5 | 0 |

*⅔ Silverlon bandage squares had ⅕ replicates displaying CPE.

Results:

It is concluded that Silverlon® has strong antiviral activity against SARS-CoV-2. Silverlon® contact led to over 5 log reductions in CPE compared to untreated virus or nylon alone at 2, and 4 hours, with a 4.5 log reduction at 6 hours of contact time. It is important to note that at the 2 hour time point 2/3 Silverlon® squares each had 1/5 replicates at the 10¹ dilution display CPE; however, this is not enough to calculate a TCID50 titer via the Reed-Muench method so the titer was still marked as 0. The Silverlon® squares at subsequent time points did not have any CPE observed for any dilution. The highest level of complete inhibition compared to untreated virus was seen with 4 h of contact time, with no CPE was observed in any of the Silverlon® wells. A gradual reduction in untreated virus viability was observed over the course of this experiment, but robust virus titers were still able to be recovered at all time points.

### Example 2. Antimicrobial Activity after Washing

Materials and Methods:

Biosan Laboratories Inc. of Warren, Mich. completed testing of material made with silver threads per ASTM E2149-01 Standard Test Method for Determining the Antimicrobial Activity of Immobilized Antimicrobial Agents Under Dynamic Contact Conditions. The test fabric was considered worst case as it contains significantly less silver threads and therefore less silver ions as compared to Silverlon®. The ASTM E2149-01 test method is designed to evaluate the resistance of non-leaching antimicrobial treated specimens to the growth of microbes under dynamic contact conditions. The antimicrobial activity of the treated specimens is determined by shaking the surface-bond antimicrobial containing samples in a bacterial suspension for a designated contact time and comparing the surviving bacteria levels against a bacterial inoculum only control sample after the specific contact time.

Results:

Two tests were completed, Test A and Test B. Both tests evaluated and demonstrated that the antimicrobial effectiveness of the test fabric after 200 laundry cycles against Methicillin Resistant Staphylococcus aureus (MRSA) ATCC #33591 was maintained. In the Test A report, test fabric contact resulted in a 5-log reduction (99.95% kill) at 1 hour and >99.99% kill at 4 hours contact time. In the Test B report, test fabric contact resulted in a 3-log reduction (99.93% kill) at 4 hours contact time. Since the action of silver ions is the biocidal mechanism across bacteria and virus pathogens, this laundry cycle testing is also applicable to the preservation of antiviral activity.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

We claim:

1. An antimicrobial and antiviral face mask comprising,
a mask body comprising at least one layer of a silver-coated material, wherein the mask body is shaped such that it covers at least the mouth and nose of a subject, and
a means to affix the face mask to the subject's face, wherein the means to affix the face mask to the subject's face is connected to the body of the mask.

2. The face mask of claim 1, wherein the silver-coated material is a fabric comprising woven silver-plated porous nylon.

3. The face mask of claim 2, wherein the silver-plated porous nylon is plated with 90% to 99% silver and 1% to 10% silver oxide.

4. The face mask of claim 1, wherein the means to affix the face mask to a subject's face comprise ear loops.

5. The face mask of claim 1, wherein the means to affix the face mask to a subject's face comprise tie straps.

6. The face mask of claim 1, wherein the body further comprises additional layers.

7. The face mask of claim 6, wherein the additional layer comprises a filter layer.

8. The face mask of claim 7, wherein the filter layer is a hepafilter.

9. The face mask of claim 1, further comprising a pocket for a hepafilter.

10. The face mask of claim 9, wherein the pocket is between two layers of silver-coated material.

11. The face mask of claim 6, wherein the additional layer is a non-silver-coated fabric layer on the side of the face mask body that contacts the subject's face.

12. The face mask of claim 1, wherein the face mask body comprises two layers of silver-coated material.

13. The face mask of claim 1, wherein the body comprises a single piece of silver-coated material, and the means to affix the mask to the subject's face comprise ear loops cut from the body material.

14. The face mask of claim 1, wherein the body comprises more than one piece of fabric held together with nylon thread.

15. The face mask of claim 1, wherein the silver is activated by moisture and kills viruses and microbes that contact the mask.

16. An antiviral and antimicrobial face mask, comprising,
at least one layer of a silver-coated fabric, wherein the silver-coated fabric comprises woven porous nylon plated with 90% to 99% silver and 1% to 10% silver oxide, and wherein the fabric comprises ear loops cut from the fabric.

17. A method of reducing viral transmission to a subject, comprising, affixing to the face of the subject the face mask of claim 1, wherein activation of the silver by moisture from the subject's breath inactivates, kills, or reduces virus particles that remain in contact with the face mask

18. The method of claim 16, wherein the virus particles are inactivated, killed, or reduced within 2 hours of continuous contact.

19. The method of claim 16, wherein the virus particles are inactivated, killed, or reduced within 1 hour of contact.

20. The method of claim 16, wherein the virus is SARS-CoV-2 virus.

21. The method of claim 20, wherein the SARS-CoV-2 virus is inactivated by a 5-log reduction within two hours of continuous contact.
